(19) United States
(12) Patent Application Publication
(10) Pub. No.: US 2014/0106621 A1
(43) Pub. Date: Apr. 17, 2014

(54) MEMORY CARD ADAPTER DEVICE

(71) Applicant: CARRY TECHNOLOGY CO., LTD., NEW TAIPEI CITY (TW)

(72) Inventor: TSUNG-CHE WU, KAOHSIUNG CITY (TW)

(73) Assignee: CARRY TECHNOLOGY CO., LTD., NEW TAIPEI CITY (TW)

(21) Appl. No.: 13/794,667

(22) Filed: Mar. 11, 2013

(30) Foreign Application Priority Data
Oct. 11, 2012 (TW) 101219623

(51) Int. Cl. G06K 19/063

(52) U.S. Cl. CPC G06K 19/063
USPC 439/630

(57) ABSTRACT

A memory card adapter device made of electricity insulating materials is exemplarily illustrated, and shape of the memory card adapter device is a pentagon. The memory card adapter device is used to switch a mini memory card or a micro memory card, and the memory card adapter includes a linking portion, a socket portion, and a transmission interface. The linking portion is a connection interface, having a plurality of metal conductive touch points used to be electrically connected to computer equipment. The socket portion is used to accommodate the mini the memory card or micro memory card. The transmission interface located inside the socket portion is used to electrically connect the mini memory card or the micro memory card, and the linking portion. A length of a distance between a longer side of the linking portion to an opposite side of which is 20 millimeters to 25 millimeters.

### BACKGROUND OF THE DISCLOSURE

1. Field of the Disclosure

The present disclosure relates to a switch device; in particular, to a memory card adapter device, for a use of switching a mini memory card or a micro memory card to a memory card slot of computer equipment.

2. Description of Related Art

Living in an age of information technology, there is always a need for using a memory card or similar devices to store or read data. With a continuously updating development of information technology and an aggressive improvement of manufacture techniques, computer equipment and memory cards have become handy products in daily lives of people, and as a result, chances of using the memory card to access data are higher than ever. On the other hand, in a current market, most of the computer equipment, such as laptops or desktops, are built with a memory card slot inside, for a convenience of a user to use the memory card to access data.

In the current market, a memory card of regular size, such as a secure digital-code memory card (SD memory card), is able to be directly slotted into the memory card slot. Other than that, there is another micro memory card (or mini memory card) which is only through a memory card adapter device to be switched into the memory card slot.

On a premise of the computer equipment to be thin and small, and also for a portability in daily life and a pleasing overall look, a size of the computer equipment is always limited. Therefore, there would not be too much of room for the memory card slot built inside of the computer equipment, and as a result, when the user access data in the mini memory card or the micro memory card with the memory card adapter device to switch the mini memory card or the micro memory card to the memory card slot, only a front-end of the memory card adapter device is in the memory card slot, and a rear-end of the memory card adapter device sticks out of an accommodation of the memory card slot.

When the rear-end of the memory card adapter device is sticking out of the slot space of the memory card slot; for the user, it is obvious that there is an object sticking out of the memory card slot of the computer equipment, so that the overall look of the computer equipment is not exquisite and pleasing enough. Besides, since the rear-end of the memory card adapter device is sticking out of the slot space of the memory card slot, the sticking out part is easily touched by accident during using or carrying the memory card adapter device, and a damage to the memory card slot of the computer equipment or the memory card adapter device may be caused. In addition, there may even be an error or damage to the data transmitted if the sticking out part is touched by accident during a data transmission between the computer equipment and the micro memory card (or mini memory card).

Briefly, when the memory card adapter device of the traditional kind is slotted into certain computer equipment and sticks out of the memory card slot, the overall look of the computer equipment is less pleasing and a taste associated of people using the computer equipment is down, and it is less convenient for the user to carry or use.

### SUMMARY OF THE DISCLOSURE

In order to solve the problems mentioned above or elsewhere, the instant disclosure is provided to solve the problems related to the overall look, usage, and portability caused by slotting the memory card adapter device into the memory card slot of the computer equipment.

The present disclosure provides a memory card adapter device mainly made of electricity insulating materials, and the shape of the memory card adapter device is a pentagon. The memory card adapter device is used to switch a mini memory card or a micro memory card, and the memory card adapter includes a linking portion, a socket portion, and a transmission interface. The linking portion is a connection interface, having a plurality of metal conductive touch points used to be electrically connected to computer equipment. The socket portion is used to accommodate the mini memory card or the micro memory card. The transmission interface located inside the socket portion is used to be electrically connected to the mini memory card or the micro memory card, and the linking portion. A length of a distance between a longer side of where the linking portion is located to an opposite side of which is 20 millimeters to 25 millimeters.

In an embodiment of the present disclosure, a memory card adapter device mainly made of electricity insulating materials is provided. The memory card adapter device, whose shape is a pentagon, is used to switch a mini memory card or a micro memory card, and includes a linking portion, a socket portion, and a transmission interface, and at least a fool-proof portion. The linking portion is a connection interface, located at two adjacent sides of the pentagonal memory card adapter device, having a plurality of metal conductive touch points used to be electrically connected to computer equipment. The socket portion is located at a side adjacent to the longer side of where the linking portion is located, used to accommodate the mini memory card or the micro memory card. The transmission interface located inside the socket portion is used to be electrically connected to the mini memory card or the micro memory card and the linking portion. The fool-proof portion is located at an opposite side to the linking portion, used to prevent the memory card adapter device from slotting into an unfit memory card slot. A length of a distance between a longer side of the linking portion to an opposite side of which is 20 millimeters to 25 millimeters.

To sum up, in the embodiment of the instant disclosure, when the memory card adapter device is slotted into a less deep memory card slot of the computer equipment (for example, a MAC laptop from Apple Inc.), the rear end of the memory card adapter device does not stick out; or in other cases, a length of the rear end sticking out is relatively shortened. As a result, after the memory card adapter device is slotted into the memory card slot of the computer equipment, the computer equipment still looks exquisite and pleasing, and the user is able to carry and use the computer equipment conveniently. In addition, the memory card adapter is designed to have the fool-proof portion so that the memory card adapter device is prevented from being accidentally slotted into the memory card slot with more depth.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

FIG. 1A shows a top-view schematic diagram of a memory card adapter device according to an embodiment of the instant disclosure;

FIG. 1B shows a look-up schematic diagram of the memory card adapter device according to the embodiment of the instant disclosure;

FIG. 1C shows a top three-dimensional view of the memory card adapter device according to the embodiment of the instant disclosure;

FIG. 1D shows a look-up three-dimensional view of the memory card adapter device according to the embodiment of the instant disclosure; and

FIG. 2 shows a schematic diagram of using the memory card adapter device according to the embodiment of the instant disclosure;

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the present disclosure. As used herein, the term “and/or” includes any and all combinations of one or more of the associated listed items.

### Embodiment of Memory Card Adapter Device

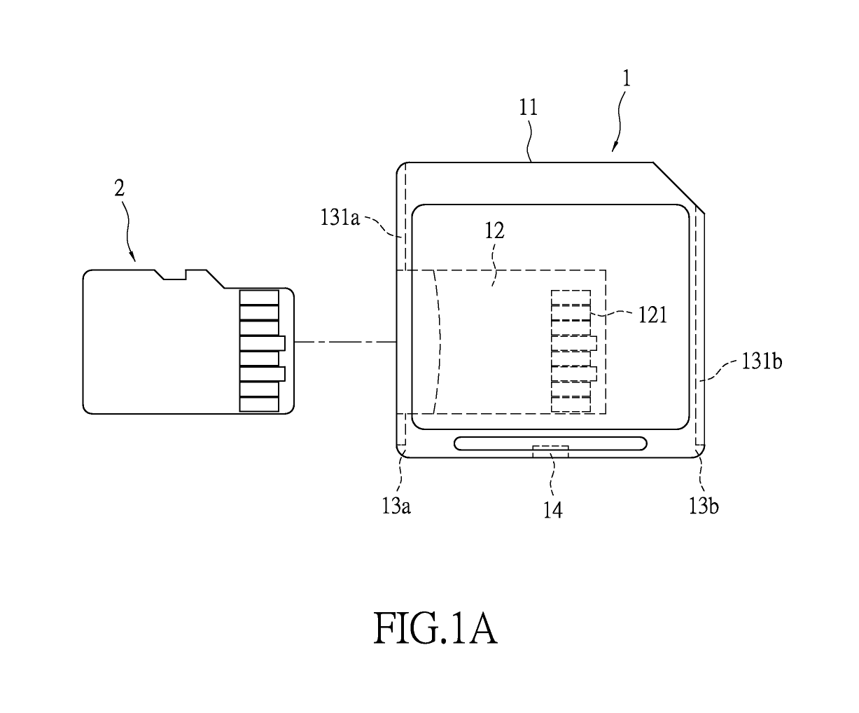

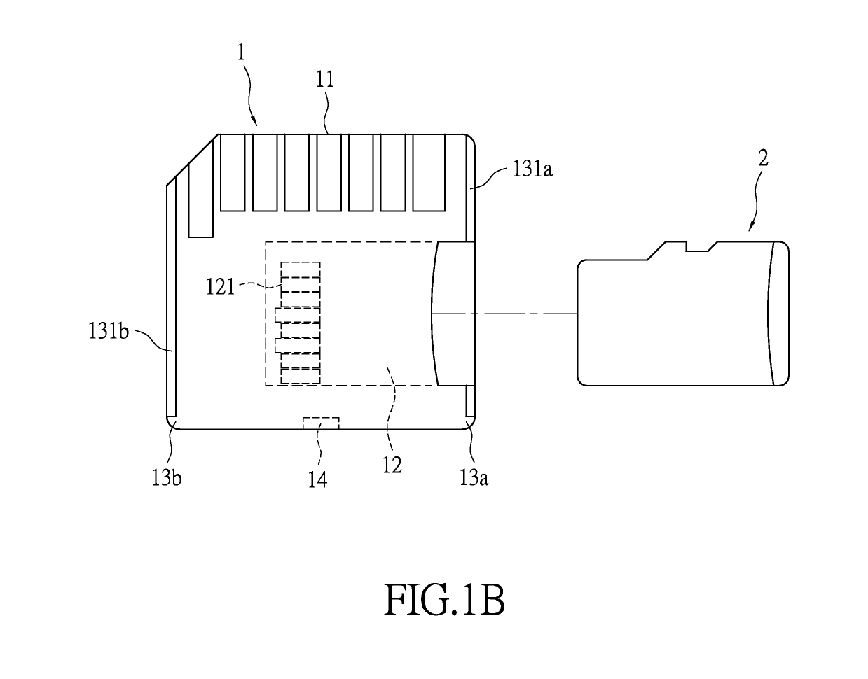

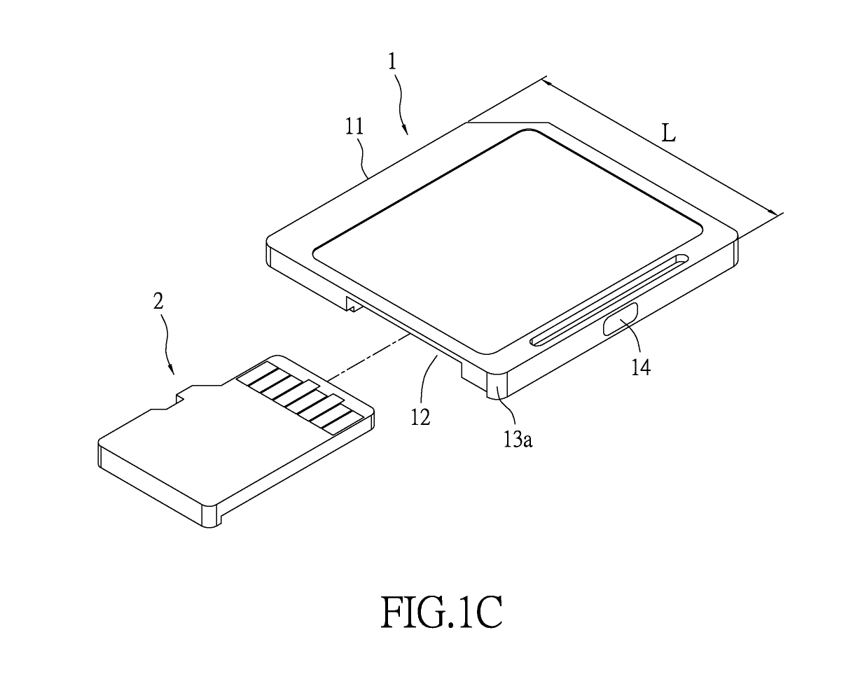

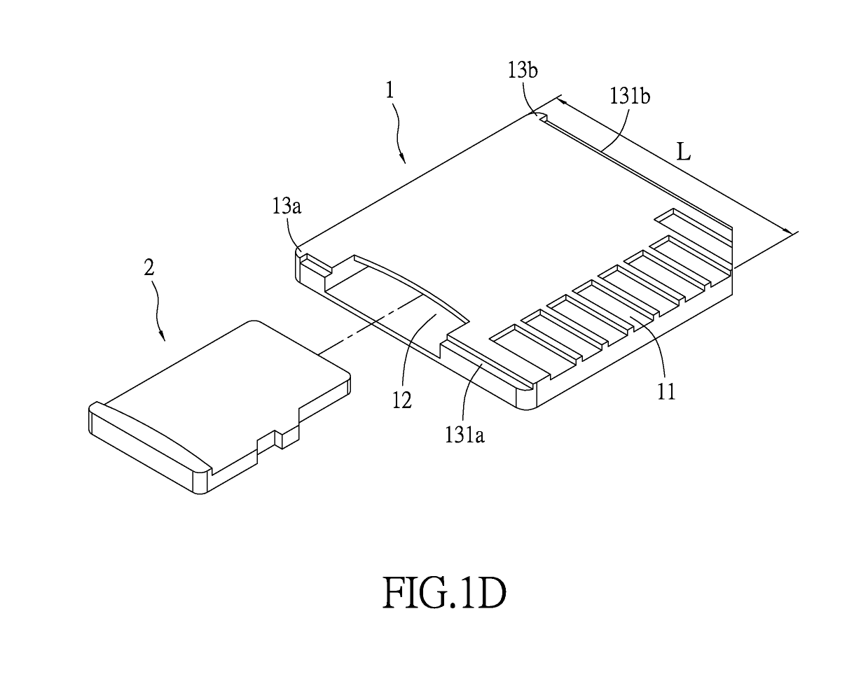

Referring to FIGS. 1A-1D, FIGS. 1A and 1B respectively show a top-view schematic diagram and a look-up schematic diagram of a memory card adapter device according to an embodiment of the instant disclosure. The memory card adapter device 1 is mainly made of electricity insulating materials, and the shape of the memory card adapter device 1 is a pentagon, and the memory card adapter 1 includes a linking portion 11, a socket portion 12, a transmission interface 121, fool-proof portions 13a and 13b, and two slide ways 131a and 131b.

In the present embodiment, the linking portion 11 is located at two adjacent sides of the pentagonal memory card adapter device 1. The linking portion 11 is actually a connection interface, and also a connecting part when the memory card adapter device 1 slotted into the memory card slot of the computer equipment. The connection interface has a plurality of metal conductive touch points used to be electrically connected to the computer equipment. In the present embodiment, a specification of the linking portion 11 may be identical to a specification of a front-end connector of a secure digital-code memory card; however, the specification of the connection interface is not limited in the instant disclosure. The specification of the connection interface of the memory card adapter device 1 just has to be identical to the specification of the front-end connector of the memory card slotted into the memory card slot of the computer equipment.

The socket portion 12 is a slot space used to accommodate the mini memory card or the micro memory card; in other words, the micro memory card 2 desired to be switched is able to be slotted in the socket portion 12. There is a transmission interface 121 in the slot space of the socket portion 12, and the transmission interface 121 is an interface used to be connected to the memory card adapter device 1 and to the mini memory card or the micro memory card 2; which means, the transmission interface 121 is used to be electrically connected to the mini memory card or the micro memory card 2 and the linking portion 11. The socket portion 12 is located at the longer side of the sides adjacent between the linking portion 11 and the opposite side to the linking portion 11.

In the present embodiment, the mini memory card 2 or the micro memory card 2 may be a mini or micro secure digital-code memory card. However, the instant disclosure is not limited thereto. The mini or micro memory card 2 may also be another kind of mini or micro memory card as long as the size of which allows it to be slotted into the memory card adapter device 1.

In the present embodiment, there are two slide ways 131a and 131b, and the slide ways 131a and 131b are respectively located at the side where the socket portion 12 is located and the side opposite to the side where the socket portion 12 is located. The slide ways 131a and 131b are able to direct the memory card adapter device 1 to be slotted into the memory card slot of the computer equipment.

In the present embodiment, a length L of the distance from the longer side of where the linking portion 11 is located to the opposite side of which may be 20 millimeters to 25 millimeters, and a length of 23 millimeters is preferable. Since the length L of the distance from the longer side of where the linking portion 11 is located to the opposite side of which may be 20 millimeters to 25 millimeters, when the memory card adapter device 1 is slotted into a less deep memory card slot of the computer equipment (for example, a MAC laptop from Apple Inc.), the rear-end of the memory card adapter device 1 does not stick out; or in other cases, a length of the rear-end sticking out is relatively shortened. As a result, after the memory card adapter device 1 is slotted into the memory card slot of the computer equipment, the computer equipment still looks exquisite and pleasing, and the user is still able to carry and use the computer equipment conveniently.

However, not all computer equipment are equipped with memory card slots which are less deep; therefore, to prevent the memory card adapter device 1 from being accidentally slotted into the memory card slot with more depth (which means, to avoid an unfit memory card slot being chosen by the user), and causing a damage to the memory card slot of the computer equipment and the memory card adapter device 1, the memory card adapter device 1 is designed to have two fool-proof portions 13a and 13b. The fool-proof portions 13a and 13b are used to prevent the memory card adapter device 1 from being accidentally slotted into the memory card slot in an unsuitable way and causing the damage to the memory card slot of the computer equipment and the memory card adapter device 1.

In the present embodiment, the fool-proof portions 13a and 13b may respectively be extruded parts at bottoms of the slide ways 131a and 131b. In other words, the fool-proof portions 13a and 13b are located at opposite sides to the linking portion 11 and respectively extruded off the slide ways 131a and 131b. Furthermore, the instant disclosure is not limited to the number or the positions of the fool-proof portions 13a and 13b in the present embodiment. In another embodiment, a fool-proof portion may be at least an extruded part, such as a fool-proof horizontal strip, located opposite on the linking portion.

Besides, the memory card adapter device 1 may also include at least a light indication unit 14, wherein the light indication unit 14 is located opposite to the linking portion 11. The light indication unit 14 is used to indicate whether the mini memory card 2 or the micro memory card 2 is under a status of being electrically connected or a status of transmitting data. Moreover, the light indication unit 14 may also be a use for entertainment or a plus for an overall look.

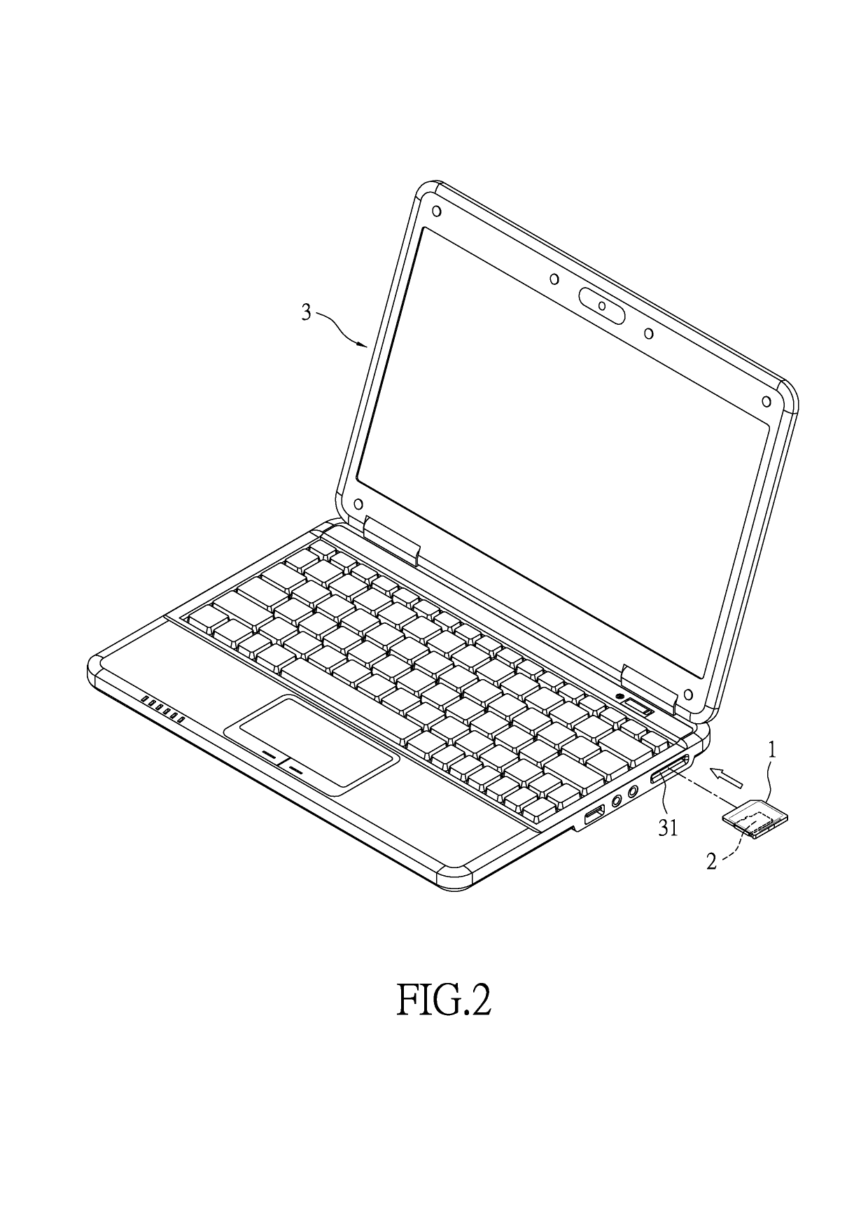

Referring to FIG. 2, FIG. 2 shows a schematic diagram of using the memory card adapter device according to the embodiment of the instant disclosure. Computer equipment 3 may be a laptop, such as a MAC laptop from Apple Inc., the computer equipment 3 has a memory card slot 31. When the mini memory card 2 or the micro memory card 2 is slotted into a socket portion 12 of the memory card adapter device 1, and the mini memory card or the micro memory card 2 exactly fits the socket portion 12, and then the memory card adapter device 1 is ready to be slotted into a memory card slot 31 of the computer equipment 3, and to finish a switching operation of the mini memory card 2 or the micro memory card 2. As a result, the memory card adapter device 1 is exactly set in an accommodation of the memory card slot 31 of the computer equipment 3, and there is no extra part sticking out, so that an objective of keeping a pleasing overall look and safety is achieved.

Other than the above descriptions, the mini memory card 2 or the micro memory card 2 and the memory card adapter device 1 may also be directly united, and it is resulted in a memory card device of a specific specification. When the memory card device of the specific specification is slotted in the memory card slot 31 of the computer equipment 3, there is nothing sticking out of the memory card slot 31; and also with a help of a fool-proof portion, it is able to prevent the memory card device from being slotted into the memory card slot with more depth.

To sum up, in the embodiment of the instant disclosure, when the memory card adapter device is slotted into a less deep memory card slot of the computer equipment (for example, a MAC laptop from Apple Inc.), the rear-end of the memory card adapter device does not stick out; or in other cases, the length of the rear-end sticking out is relatively shortened. As a result, after the memory card adapter device is slotted into the memory card slot of the computer equipment, the computer equipment still looks exquisite and pleasing, and the user is able to carry and use the computer equipment conveniently. In addition, the memory card adapter is designed to have the fool-proof portion so that the memory card adapter device is prevented from being accidentally slotted into the memory card slot with more depth.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A memory card adapter device, mainly made of electricity insulating materials, used to switch a mini memory card or a micro memory card, and a shape of the memory card adapter device is a pentagon, comprising:
a linking portion, as a connection interface, having a plurality of metal conductive touch points used to be electrically connected to a computer equipment;
a socket portion, used to accommodate the mini memory card or the micro memory card; and
a transmission interface, located inside the socket portion, used to electrically connect to the mini memory card or the micro memory card, and the linking portion;
wherein a length of a distance between a longer side of where the linking portion is located to an opposite side of which is 20 millimeters to 25 millimeters.

2. The memory card adapter device according to claim 1, further comprising at least a fool-proof portion, used to prevent the memory card adapter device from slotting into an unfit memory card slot.

3. The memory card adapter device according to claim 2, wherein the linking portion is located at two adjacent sides of the pentagon, and the fool-proof portion is located at an opposite side to the linking portion, and the socket portion is located at the side adjacent to the longer side of where the linking portion is located.

4. The memory card adapter device according to claim 1, wherein a length of a distance from the longer side of where the linking portion is located to an opposite side of which is 23 millimeters.

5. The memory card adapter device according to claim 1, wherein a connection specification of the linking portion is the connection specification of a secure digital-code memory card, and the mini memory card or the micro memory card is a mini or micro secure digital-code memory card.

6. The memory card adapter device according to claim 2, wherein the memory card adapter device further comprising two slide ways, and the slide ways are respectively located at the side where the socket portion is located and the side opposite to where the socket portion is located.

7. The memory card adapter device according to claim 6, wherein the at least a fool-proof portion is two fool-proof portions, and is extruded parts at bottoms of the two slide ways.

8. The memory card adapter device according to claim 1, wherein there is a light indication unit located opposite to the linking portion.

9. The memory card adapter device according to claim 1, wherein the memory card adapter device fits a MAC laptop from Apple Inc.

10. A memory card adapter device, mainly made of electricity insulating materials, used to switch a mini memory card or a micro memory card, and a shape of the memory card adapter device is a pentagon, comprising:
a linking portion, as a connection interface, located at two adjacent sides of the pentagon, having a plurality of metal conductive touch points used to be electrically connected to a computer equipment;
a socket portion, located at an adjacent side to a longer side of where the linking portion is located, used to accommodate the mini memory card or the micro memory card;
a transmission interface, located inside the socket portion, used to electrically connect to the mini memory card or the micro memory card and the linking portion; and
at least a fool-proof portion, used to prevent the memory card adapter device from being slotted into an unfit memory card slot. wherein a length of a distance between a longer side of where the linking portion is located to an opposite side of which is 20 millimeters to 25 millimeters.

11. The memory card adapter device according to claim 10, wherein the length of the distance from the longer side of where the linking portion is located to an opposite side of which is 23 millimeters.

12. The memory card adapter device according to claim 10, wherein a connection specification of the linking portion is the connection specification of a secure digital-code memory card, and the mini memory card or the micro memory card is a mini or micro secure digital-code memory card.

13. The memory card adapter device according to claim 10, wherein the memory card adapter device further comprising two slide ways, and the slide ways are respectively located at the side where the socket portion is located and the side opposite to where the socket portion is located.

14. The memory card adapter device according to claim 13, wherein the at least a fool-proof portion is two fool-proof portions, and is extruded parts at bottoms of the two slide ways.

15. The memory card adapter device according to claim 10, wherein there is a light indication unit located opposite to the linking portion.

16. The memory card adapter device according to claim 10, wherein the memory card adapter device fits a MAC laptop from Apple Inc.
